(19) United States
(12) Patent Application Publication
(10) Pub. No.: US 2019/0167393 A1
(43) Pub. Date: Jun. 6, 2019

(54) Scalable Frame for Fixing a Zirconium Oxidized Disk Used for Producing Dentures

(71) Applicant: Lien-Fang Chu, Taipei City (TW)

(72) Inventor: Lien-Fang Chu, Taipei City (TW)

(21) Appl. No.: 15/993,034

(22) Filed: May 30, 2018

(30) Foreign Application Priority Data
Dec. 5, 2017 (CN) 201721670362.7

(51) Int. Cl. A61C 13/00; A61C 13/20

(52) U.S. Cl. CPC A61C 13/0027; A61C 2201/00; A61C 13/20

(57) ABSTRACT

Provided is a scalable frame for fixing a zirconium oxidized disk used in producing a denture, wherein a material is used to mold a circular ring which defines a diameter and which includes a major circular section, a minor circular section and a resilient structure integrally formed the minor circular section. The minor circular section has a cross-section different from a cross section of the major circular section such that the circular ring is extendable and retractable along the diameter by virtue of the resilient structure so that the circular ring can be sleeved around the zirconium oxidized disk to facilitate fixing the zirconium oxidized disk in a denture carving machine for undergoing tooth carving process.

### CROSS-REFERENCE TO RELATED APPLICATION

This application claims the priority of Chinese patent application No. 201721670362.7, filed on Dec. 5, 2017, which is incorporated herewith by reference.

### BACKGROUND OF THE INVENTION

### 1. Field of the Invention

The present invention relates to the technical field of dental materials, more particularly to a structure for fixing a zirconium oxidized disk used for producing all-ceramic porcelain denture.

### 2. The Prior Arts

There are many options for making dentures. Among them, all-ceramic porcelain denture is the closest choice for real teeth due to its aesthetic appearance. Currently, all-ceramic porcelain dentures are generally made of zirconium ceramic materials. The zirconium material is previously sintered into a disk (hereinafter referred to as “zirconium oxidized disk”), and the zirconium oxidized disk is fixed on a jig of a CNC (computer numerical control) machine during the manufacture. Then the machine is activated to carry out tooth carving on the zirconium oxidized disk. After the cutting and carving, the porcelain dentures are then processed by dental technicians such as dressing, coloring and sintering to become all-ceramic porcelain dentures.

In order to fix the zirconium oxidized disk on the jig of the CNC machine, the zirconium oxidized disk must be and is traditionally processed to produce a structure that can be fitted to the jig. As best shown in FIGS. 1 and 2, the processing of the zirconium oxidized disk includes the following actions; the outer diameter edges of the opposite sides of the zirconium oxidized disk A are cut out in such a manner to form a flange with two planes A1 on the opposite sides such that when mounting the zirconium oxidized disk A on the CNC machine, the clamping jaw B1 of the jig B can clamp the two planes A1 to fix the zirconium oxidized disk A, and then the CNC machine is activated to carry out the carving processing.

Since the price of zirconium material is very expensive, the conventional method of cutting the zirconium oxidized disk to produce a flange structure greatly increases the material cost, which in fact can be avoided.

### SUMMARY OF THE INVENTION

The primary objective of the present invention is to solve the problem existing in the conventional manufacture of all-ceramic porcelain denture, it is necessary to machine a zirconium oxidized disk in such a manner to have a fixing structure that can be fitted to a jig of a machine, thereby reducing the loss of expensive zirconium material during the processing.

For achieving the foregoing objectives, the present invention provides a scalable frame for fixing a zirconium oxidized disk used in producing a denture, wherein a material is used to mold a circular ring which defines a diameter and which includes a major circular section having a first arc length with a first cross-section and a minor circular section having a second arc length shorter than the first arc length and provided with an integrally formed resilient structure, the minor circular section having a second cross-section different from the first cross section such that the circular ring is extendable and retractable along the diameter of the circular ring by virtue of the resilient structure.

According to an embodiment of the present invention, the first cross-section of the major circular section is greater than the second cross-section of the minor circular section. The material to mold the circular ring includes a plastic material and the circular ring has a higher rigidity than the resilient structure.

Preferably, the circular ring has two axial end surfaces both of which are flat.

According to an embodiment of the present invention, the resilient structure includes at least one elastic loop such that two radial sides of the elastic loop are respectively connected to corresponding sides of the minor circular section of the circular ring.

According to an embodiment of the present invention, the resilient structure includes a plurality of the elastic loops, two adjacent of the elastic loops are connected integrally relative to each other in a radial direction while two outermost of the elastic loops are respectively connected to the corresponding sides of the minor circular section of the circular ring.

Preferably, each of the plurality of elastic loops has an oval-shape configuration in the axial direction thereof.

Preferably, the major circular section has two first positioning holes at both sides of the resilient structure and a plurality of circumferentially formed second positioning holes.

Preferably, each of the first and second positioning holes extends through inner and outer surfaces of the major circular section of the circular ring.

In one embodiment of the present invention, the first positioning hole defines a first axis parallel to a normal line of an outer surface of the diameter of the circular ring while the second positioning hole defines a second axis intersecting with the normal line of the outer surface of the diameter of the circular ring to form an angle therebetween.

Preferably, adjacent two second positioning holes are radial symmetry correspond to the center of the circular ring.

It is to note that since the scalable frame of the present invention can be sleeved around the zirconium oxidized disk for fixing in the jig of a carving machine, once the zirconium oxidized disk is sintered, the outer diameter edges of the opposite sides of the zirconium oxidized does not need to be cut out in such a manner to form a flange so as to be clamped as in the prior art. Thus, the loss of expensive zirconium material during the processing can be avoided.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic perspective view of a conventional zirconium oxidized disk used in producing a denture;

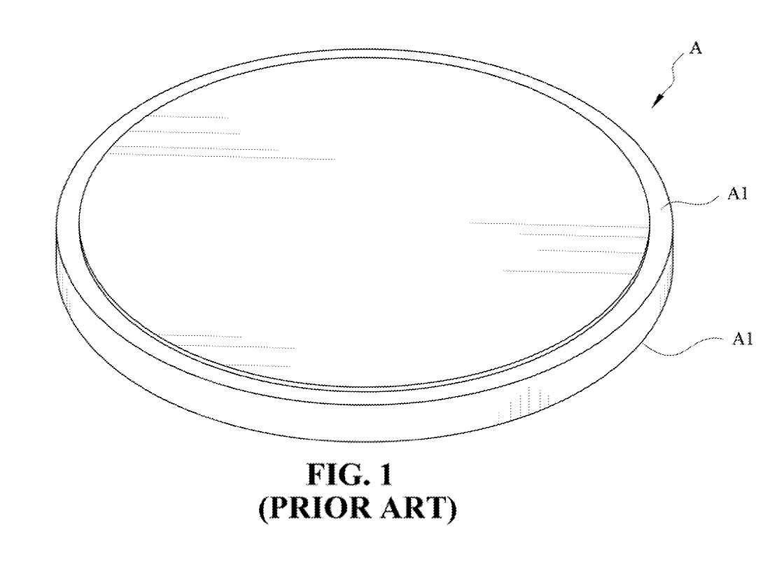

FIG. 2 is a fragmentary cross sectional view illustrating how the conventional zirconium oxidized disk is clamped by a CNC machine for producing a denture;

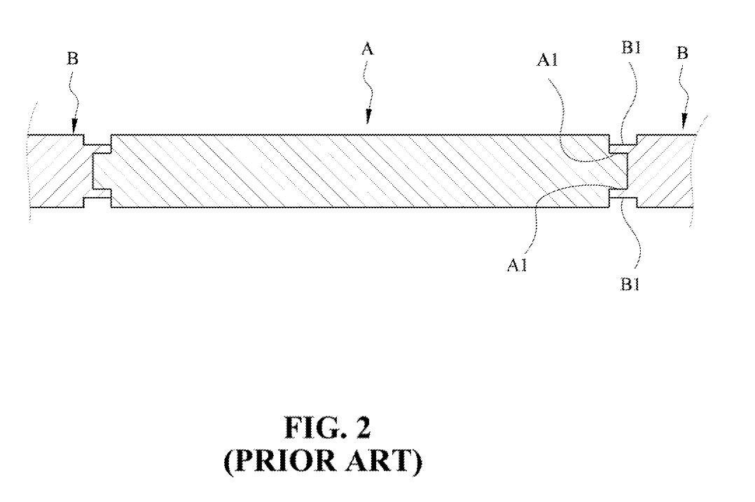

FIG. 3 is a perspective view of a scalable frame of the present invention for fixing a zirconium oxidized disk used for producing a denture;

FIG. 4 is a side view of the scalable frame of the present invention for fixing a zirconium oxidized disk used for producing a denture;

FIG. 5 is a top view of the scalable frame of the present invention for fixing a zirconium oxidized disk used for producing a denture;

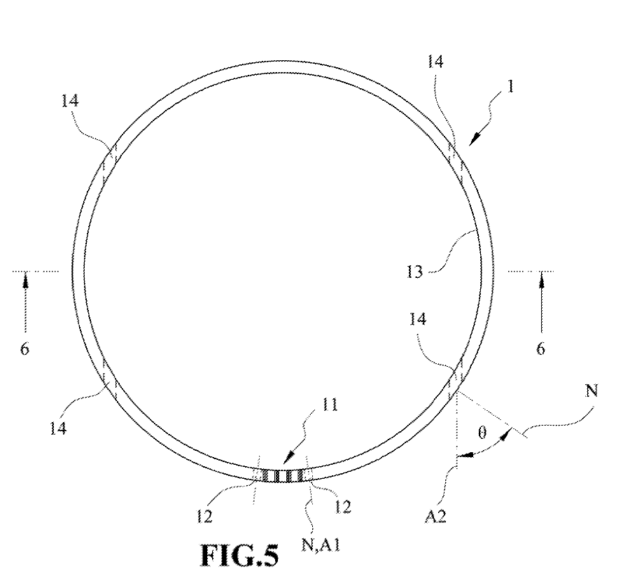

FIG. 6 is a cross sectional view of the scalable frame of the present invention taken along lines 6-6 in FIG. 5; and

FIG. 7 is a cross sectional view of the scalable frame of the present invention for fixing a zirconium oxidized disk used in producing a denture.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

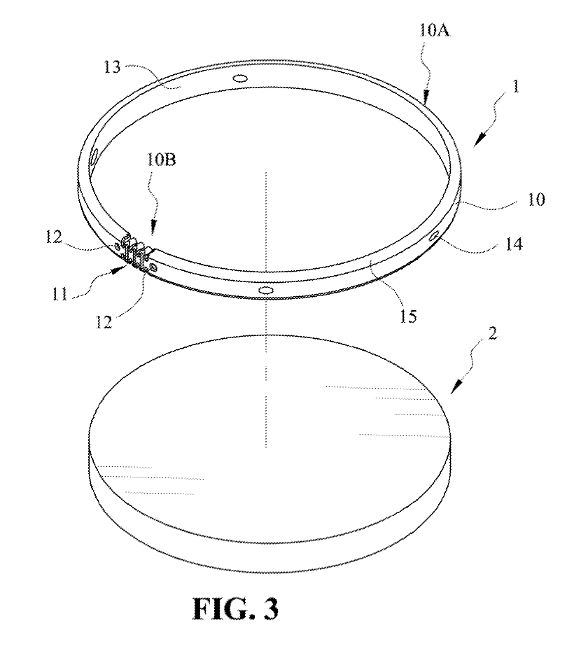

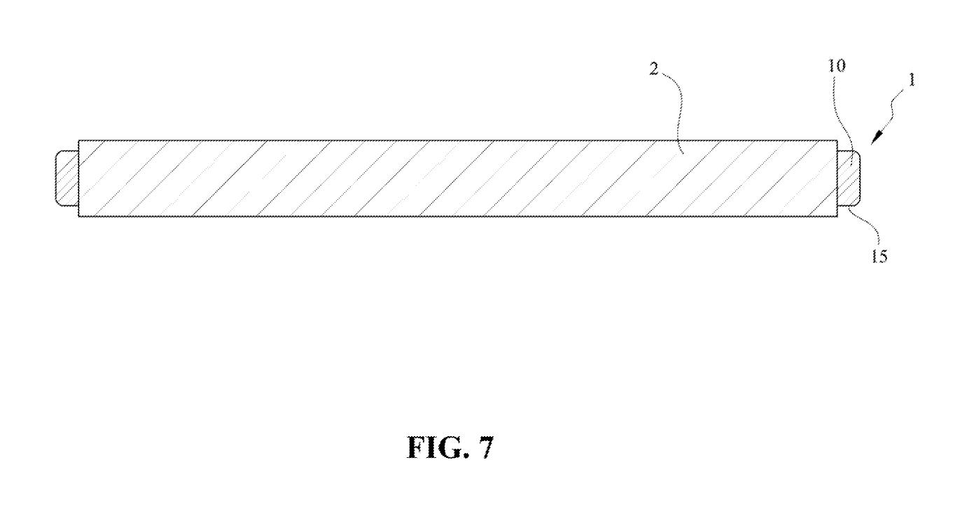

FIG. 3 is a perspective view of a scalable frame 1 of the present invention for fixing a zirconium oxidized disk 2 used for producing a denture. As best shown in FIG. 3, a material is used to mold a circular ring 10 which defines a diameter and which includes a major circular section 10A having a first arc length with a first cross-section and a minor circular section 10B having a second arc length shorter than the first arc length and provided with an integrally formed resilient structure 11. The minor circular section 10B has a second cross-section different from the first cross section such that the circular ring 10 is extendable and retractable along the diameter of the circular ring 10 by virtue of the resilient structure 11. To be more specific, a double-sided adhesive tape (not visible) can be applied on an inner peripheral surface of the circular ring 10 in order to fix the zirconium oxidized disk 2 within the circular ring 10 (see FIG. 7). Alternatively, an adhesive or glue can be applied on the outer surface of the zirconium oxidized disk 2 in order to fix the same within the circular ring 10 by virtue of extendable and retractable property along the diameter direction of the circular ring 10, such that the entire assembly can be clamped by a jig of the carving machine. The carving process is performed upon activation of the machine.

The minor circular section 10B has a gap formed at a position of the circular ring 10 so that when the circular ring 10 is wound along one circle, the gap does not continuously form a complete circle shape. However, the gap does not break the circular ring 10, but the circular ring 10 is connected with the gap through the resilient structure 11.

In this embodiment, the first cross-section of the major circular section 10A is greater than the second cross-section of the minor circular section 10B. The material to mold the circular ring 10 includes a plastic material and the circular ring 10 has a higher rigidity than the resilient structure 11. After molding, the circular ring 10 has an appropriate thickness without significant deformation, but the resilient structure 11 has a relatively high elasticity and can be deformed appropriately in the diameter direction so that an external force can be applied to expand the scalable frame 1.

In order that the scalable frame 1 can be stably fixed to the jig (not shown) of a carving machine, two axial end surfaces 15 of the circular ring 10 are machined to be flat so that when the zirconium oxidized disk 2 of the scalable frame 1 is assembled with the jig of the carving machine, the planes 15 of the circular ring 10 are clamped fixedly by the jig, thereby fixing the zirconium oxidized disk 2 relative to the carving machine.

Preferably, the resilient structure 11 includes a plurality of elastic loops 110 such that two radial sides of each elastic loop 110 are respectively connected to corresponding sides of the minor circular section 10B of the circular ring. As best shown in FIG. 3, there are three elastic loops 110, wherein adjacent two of the elastic loops 110 are connected integrally relative to each other in a radial direction while two outermost of the elastic loops 110 are respectively connected to the corresponding sides of the minor circular section 10B of the circular ring 10. Each of the elastic loops 110 has an oval-shape configuration in the axial direction thereof and an elongated opening 111. Owing to the elongated openings 111 in the elastic loops 110, the surface area of the inner peripheral surface 13 of the circular ring 10 can be increased when the circular ring 10 is extended forcibly and outwardly in a radial direction thereof. Once the external force is removed from the circular ring 10, the latter may retrieve to its initial shape due to the restoration force or contraction of the resilient structure 11.

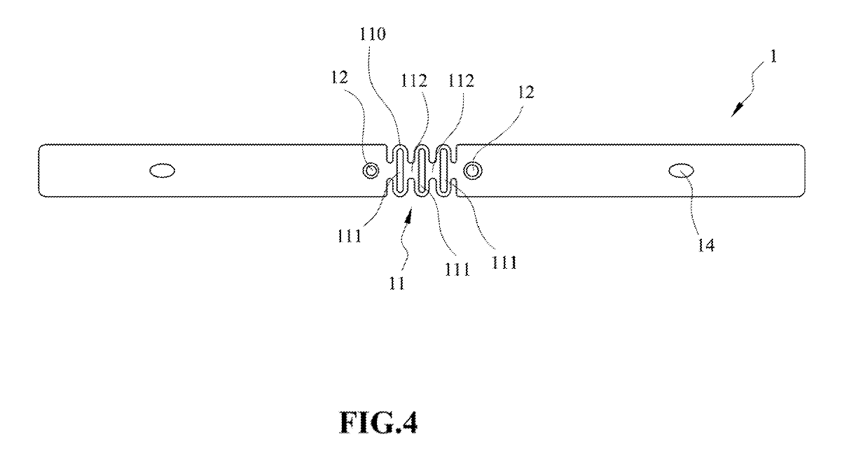

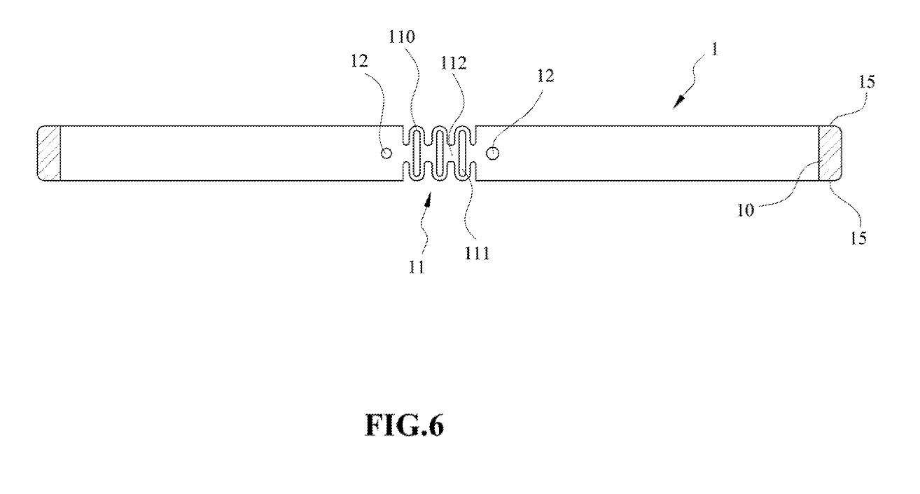

Though each of the elastic loops 110 has an oval-shape configuration in the axial direction thereof, as best shown in FIGS. 4 and 6, many other suitable geometric shapes should be included in the axial direction thereof.

In order to sleeve the scalable frame 1 around the zirconium oxidized disk 2, a tool must be applied to extend the circular ring 10 in the radial direction such that the inner peripheral surface area of the circular ring is increased, only then the circular ring 10 can be sleeved around the zirconium oxidized disk 2, as best shown in FIGS. 4 and 6. Preferably, the major circular section 10A of the circular ring 10 has two first positioning holes 12 at both sides of the resilient structure 111 and a plurality of circumferential second positioning holes 14. Each of the first and second positioning holes 12, 14 extends through the inner and outer surfaces of the circular ring 10. More preferably, the first positioning hole 12 defines a first axis A1 parallel to a normal line N of an outer surface of the diameter of the circular ring 10 while the second positioning hole 14 defines a second axis A2 intersecting with the normal line of the outer surface of the diameter of the circular ring 10 to form an angle θ therebetween. In one embodiment of the present invention, adjacent two second positioning holes 14 are radial symmetry correspond to the center of the circular ring 10. Owing to these specific structures, when it is desired to expand the circular ring 10 in the radial direction, a special tool can be applied to hook either the first positioning hole 12 or the second positioning hole 14 for exerting the external force, hence expanding the scalable frame 1 of the present invention and changing the inner surface area 13 of the circular ring 10. Upon release of the external force, the circular ring 10 may retrieve to its initial shape by virtue of the restoration force.

Since the scalable frame 1 of the present invention can be sleeved around the zirconium oxidized disk for fixing in the jig of a carving machine, once the zirconium oxidized disk is sintered, the outer diameter edges of the opposite sides of the zirconium oxidized need not be cut out in such a manner to form a flange so as to be clamped as in the prior art. Thus, the loss of expensive zirconium material during the processing can be avoided.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A scalable frame for fixing a zirconium oxidized disk used in producing a denture, wherein a material is used to mold a circular ring which defines a diameter and which includes a major circular section having a first arc length and a first cross-section and a minor circular section having a second arc length shorter than the first arc length and provided with an integrally formed resilient structure, the minor circular section having a second cross-section different from the first cross section such that the circular ring is extendable and retractable along the diameter of the circular ring by virtue of the resilient structure.

2. The scalable frame according to claim 1, wherein the material to mold the circular ring includes a plastic material and the circular ring has a higher rigidity than the resilient structure.

3. The scalable frame according to claim 2, wherein the circular ring has two axial end surfaces both of which are flat.

4. The scalable frame according to claim 3, wherein the resilient structure includes at least one elastic loop such that two radial sides of the elastic loop are respectively connected to corresponding sides of the minor circular section of the circular ring.

5. The scalable frame according to claim 4, wherein the resilient structure includes a plurality of elastic loops, two adjacent of the elastic loops are connected integrally relative to each other in a radial direction while two outermost of the elastic loops are respectively connected to the corresponding sides of the minor circular section of the circular ring.

6. The scalable frame according to claim 5, wherein each of the plurality of elastic loops has an oval-shape configuration in the axial direction thereof.

7. The scalable frame according to claim 5, wherein the major circular section has two first positioning holes at both sides of the resilient structure and a plurality of circumferentially formed second positioning holes.

8. The scalable frame according to claim 6, wherein the major circular section has two first positioning holes at both sides of the resilient structure and a plurality of circumferentially formed second positioning holes.

9. The scalable frame according to claim 8, wherein the first and second positioning holes extend through inner and outer surfaces of the major circular.

10. The scalable frame according to claim 9, wherein the first positioning hole defines a first axis parallel to a normal line of an outer surface of the diameter of the circular ring while the second positioning hole defines a second axis intersecting with the normal line of the outer surface of the diameter of the circular ring to form an angle therebetween.

11. The scalable frame according to claim 10, wherein adjacent two of the second positioning holes are radially symmetric relative to a center of the circular ring.
